(19) United States
(12) Patent Application Publication
(10) Pub. No.: US 2017/0153114 A1
(43) Pub. Date: Jun. 1, 2017

(54) Vehicle with interaction between vehicle navigation system and wearable devices

(71) Applicant: BRAGI GmbH, München (DE)

(72) Inventor: Peter Vincent Boesen, München (DE)

(21) Appl. No.: 15/356,978

(22) Filed: Nov. 21, 2016

Related U.S. Application Data
(60) Provisional application No. 62/260,441, filed on Nov. 27, 2015.

(51) Int. Cl. G01C 21/34; G01C 21/36; G01C 21/16

(52) U.S. Cl. CPC G01C 21/3423; G01C 21/165; G01C 21/3661; G01C 21/3688

(57) ABSTRACT

A system includes a vehicle, a vehicle network disposed within the vehicle, and a navigation system disposed within the vehicle. The navigation system is configured to wirelessly communicate with at least one wireless earpiece to communicate navigation data to or from the at least one wireless earpiece. The navigation data includes a geospatial position. The navigation data include directions. The directions may include a first subset of directions for directions for use when driving the vehicle and a second subset of directions for directions for use when walking. The navigation data may include destination data. The navigation data may include calibration data. The system may further include at least one wireless earpiece and the at least one wireless earpiece comprises an inertial sensor.

### PRIORITY STATEMENT

This application claims priority to U.S. Provisional Patent Application 62/260,441, filed on Nov. 27, 2015, and entitled Vehicle with interaction between vehicle navigation system and wearable devices, hereby incorporated by reference in its entirety.

### FIELD OF INVENTION

The present invention relates to wearable devices. More particularly, but not exclusively, the present invention relates to interactions between wearable devices such as earpieces and vehicle navigation systems.

### BACKGROUND

Vehicles may come with various types of electronics packages. These packages may be standard or optional and include electronics associated with communications or entertainment. However, there are various problems and deficiencies with such offerings. What is needed are vehicles with improved electronics options which create, improve, or enhance overall experience of vehicles. In particular, what is needed are vehicles which integrate with wearable devices.

### SUMMARY

Therefore, it is a primary object, feature, or advantage of the present invention to improve over the state of the art.

It is another object, feature, or advantage of the present invention to communicate between vehicle systems and wearable devices.

It is a further object, feature, or advantage of the present invention to use wearable devices within vehicles and to provide enhanced vehicle functionality.

It is another object, feature, or advantage of the present invention to enhance the navigation system of a vehicle.

One or more of these and or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect a system includes a vehicle, a vehicle network disposed within the vehicle, and a navigation system disposed within the vehicle. The navigation system is configured to wirelessly communicate with at least one wireless earpiece to communicate navigation data to or from the at least one wireless earpiece. The navigation data includes a geospatial position. The navigation data include directions. The directions may include a first subset of directions for directions for use when driving the vehicle and a second subset of directions for directions for use when walking. The navigation data may include destination data. The navigation data may include calibration data. The system may further include at least one wireless earpiece and the at least one wireless earpiece comprises an inertial sensor. The earpiece may include a processor operatively connected to the inertial sensor and wherein the processor is configured to update a current position based on changes in position determined by the inertial sensor. The processor may be configured to calibrate with a geospatial position when the earpiece is within the vehicle. The processor may be configured to calibrate with a geospatial position when the earpiece is worn by a driver of the vehicle seated in a driver's seat. The navigation data may include an offset defining a distance between a geolocation system antenna of the vehicle and a position for use in calibration of the at least one wireless earpiece.

According to another aspect, a method of navigation using a vehicle navigation system of a vehicle and a wearable device is provided. The method may include computing directions from a current location to a destination using the vehicle navigation system wherein a first part of the directions are driving directions to an intermediate location and wherein a second part of the directions are walking directions from the intermediate location to the destination and electronically handing off navigation from the vehicle navigation system to the wearable device such that the wearable device provides the walking directions from the intermediate location to the destination after arrival at the intermediate location. The wearable device may be an earpiece or instead of a wearable device a mobile device such as a phone may be used. The device may include a geolocation receiver such as a GPS receiver or may include at least one inertial sensor for tracking movement. The method may include calibrating position of the wearable device to position of the vehicle. The method may include calibrating orientation of the wearable device to the position of the vehicle.

### BRIEF DESCRIPTION OF THE DRAWINGS

FIG. 1 illustrates one example of use of a wearable device in conjunction with a vehicle.

FIG. 2 illustrates a wearable device in the form of a set of ear pieces.

FIG. 3 is a block diagram illustrating a device.

FIG. 4 illustrates a system which includes ear pieces in communication with a vehicle.

FIG. 5 illustrates a wearable device in communication with a vehicle navigation system.

### DETAILED DESCRIPTION

Some of the most important factors in selecting a vehicle such as car may be the technology available to enhance the experience. This may be of particular importance in certain vehicle segments such as for luxury vehicles. Another important factor in selecting a vehicle may be the available safety features. According to various aspects, the present invention allows for wearable devices including ear pieces to enhance the experience of vehicles and according to some aspects, the present invention allows for wearable devices such as earpieces to enhance the overall safety of the vehicle. Therefore, it is expected that the technology described herein will make any vehicle so equipped more desirable to customers, more satisfying to customers, and potentially more profitable for the vehicle manufacturer. Similarly at least some of the various aspects may be added to existing vehicles as after-market accessories to improve the safety or experience of existing vehicles.

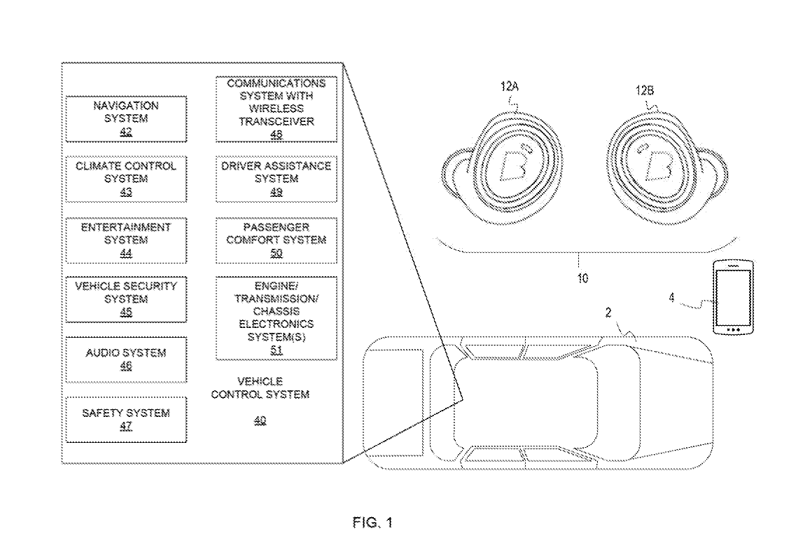

FIG. 1 illustrates one example of use of a wearable device in conjunction with a vehicle. A shown in FIG. 1 there is a vehicle 2. Although the vehicle shown is a full-size sedan, it is contemplated that the vehicle may be of any number of types of cars, trucks, sport utility vehicles, vans, mini-vans, automotive vehicles, commercial vehicles, agricultural vehicles, construction vehicles, specialty vehicles, recreational vehicles, buses, motorcycles, aircraft, boats, ships, yachts, spacecraft, or other types of vehicles. The vehicle may be gas-powered, diesel powered, electric, solar-powered, or human-powered. The vehicle may be actively operated by a driver or may be partially or completely autonomous or self-driving. The vehicle 2 may have a vehicle control system 40. The vehicle control system is a system which may include any number of mechanical and electromechanical subsystems. As shown in FIG. 1, such systems may include a navigation system 42, an entertainment system 44, a vehicle security system 45, an audio system 46, a safety system 47, a communications system 48 preferably with is a wireless transceiver, a driver assistance system 49, a passenger comfort system 50, and an engine/transmission, chassis electronics system(s) 51. Of course, other examples of vehicle control sub-systems are contemplated. In addition, it is to be understood that there may be overlap between some of these different vehicle systems and the presence or absence of these vehicle systems as well as other vehicle systems may depend upon the type of vehicle, the type of fuel or propulsion system, the size of the vehicle, and other factors and variables. In the automotive context, examples of the driver assistance system 49 may include one or more subsystems such as a lane assist system, a speed assist system, a blind spot detection system, a park assist system, and an adaptive cruise control system. In the automotive context, examples of the passenger comfort system 50 may include one or more subsystems such as automatic climate control, electronic seat adjustment, automatic wipers, automatic headlamps, and automatic cooling. In the automotive context, examples of the safety system 47 may include active safety systems such as air bags, hill descent control, and an emergency brake assist system. Aspects of the navigation system 42, the entertainment system 44, the audio system 46, and the communications system 48 may be combined into an infotainment system.

One or more wearable devices such as a set of earpieces 10 including a left earpiece 12A and a right earpiece 12B may in operative communication with the vehicle control system 40 such as through the communication system 48. For example, the communication system 48 may provide a Bluetooth or BLE link to wearable devices or may otherwise provide for communications with the wearable devices preferably through wireless communications. The vehicle 2 may communicate with the wearable device(s) directly, or alternatively, or in addition, the vehicle ² may communicate with the wearable device(s) through an intermediary device such as a mobile device 4 which may be a mobile phone, a tablet, or other type of mobile device.

As will be explained in further details with respect to various examples, the wearable device(s) 10 interact with the vehicle control system 40 in any number of different ways. For example, the wearable device(s) 10 may provide sensor data, identity information, stored information, streamed information, or other types of information to the vehicle. Based on this information, the vehicle may take any number of actions which may include one or more actions taken by the vehicle control system (or subsystems thereof). In addition, the vehicle 2 may communicate sensor data, identity information, stored information, streamed information or other types of information to the wearable device(s) 10.

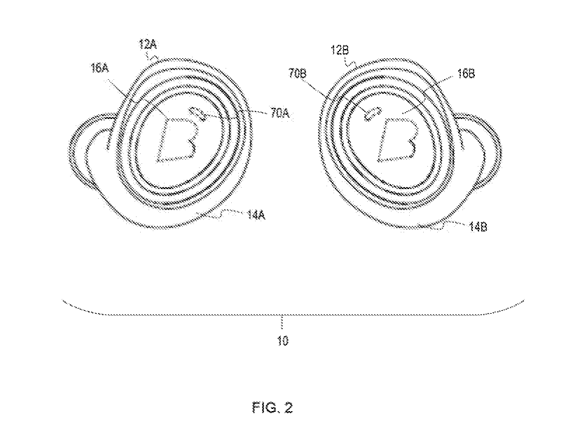

FIG. 2 illustrates one example of a wearable device in the form of a set of ear pieces 10 greater detail. FIG. 1 illustrates a set of earpiece wearables 10 which includes a left earpiece 12A and a right earpiece 12B. Each of the earpieces wearables 12A, 12B has an earpiece wearable housing 14A, 14B which may be in the form of a protective shell or casing and may be an in-the-ear earpiece housing. A left infrared through ultraviolet spectrometer 16A and right infrared through ultraviolet spectrometer 16B is also shown. Each earpiece 12A, 12B may include one or more microphones 70A, 70B. Note that the air microphones 70A, 70B are outward facing such that the air microphones 70A, 70B may capture ambient environmental sound. It is to be understood that any number of microphones may be present including air conduction microphones, bone conduction microphones, or other audio sensors.

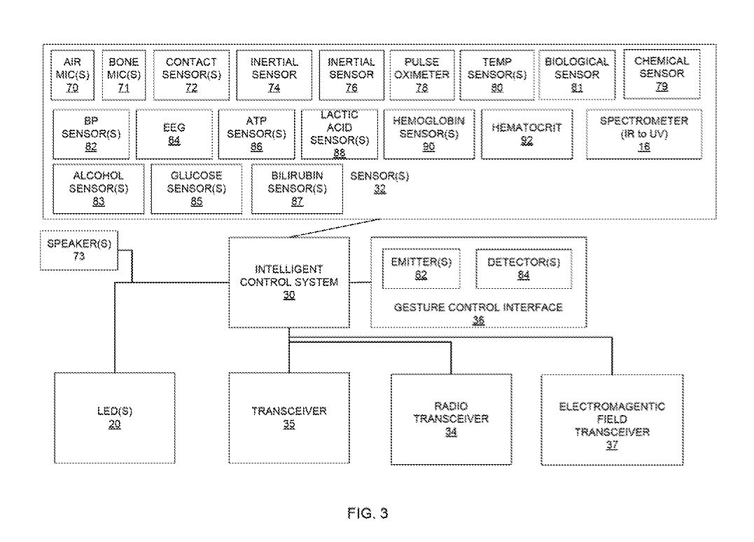

FIG. 3 is a block diagram illustrating a device. The device may include one or more LEDs 20 electrically connected to an intelligent control system 30. The intelligent control system 30 may include one or more processors, microcontrollers, application specific integrated circuits, or other types of integrated circuits. The intelligent control system 30 may also be electrically connected to one or more sensors 32. Where the device is an earpiece, the sensor(s) may include an inertial sensor 74, another inertial sensor 76. Each inertial sensor 74, 76 may include an accelerometer, a gyro sensor or pyrometer, a magnetometer or other type of inertial sensor. The sensor(s) 32 may also include one or more contact sensors 72, one or more bone conduction microphones 71, one or more air conduction microphones 70, one or more chemical sensors 79, a pulse oximeter 76, a temperature sensor 80, or other physiological or biological sensor(s). Further examples of physiological or biological sensors include an alcohol sensor 83, glucose sensor 85, or bilirubin sensor 87. Other examples of physiological or biological sensors may also be included in the device. These may include a blood pressure sensor 82, an electroencephalogram (EEG) 84, an Adenosine Triphosphate (ATP) sensor, a lactic acid sensor 88, a hemoglobin sensor 90, a hematocrit sensor 92 or other biological or chemical sensor.

A spectrometer 16 is also shown. The spectrometer 16 may be an infrared (IR) through ultraviolet (UV) spectrometer although it is contemplated that any number of wavelengths in the infrared, visible, or ultraviolet spectrums may be detected. The spectrometer 16 is preferably adapted to measure environmental wavelengths for analysis and recommendations and thus preferably is located on or at the external facing side of the device.

A gesture control interface 36 is also operatively connected to or integrated into the intelligent control system 30. The gesture control interface 36 may include one or more emitters 82 and one or more detectors 84 for sensing user gestures. The emitters may be of any number of types including infrared LEDs The device may include a transceiver 35 which may allow for induction transmissions such as through near field magnetic induction. A short range transceiver 34 using Bluetooth, BLE, UWB, or other means of radio communication may also be present. The short range transceiver 34 may be used to communicate with the vehicle control system. In operation, the intelligent control system 30 may be configured to convey different information using one or more of the LED(s) 20 based on context or mode of operation of the device. The various sensors 32, the processor 30, and other electronic components may be located on the printed circuit board of the device. One or more speakers 73 may also be operatively connected to the intelligent control system 30.

An electromagnetic (E/M) field transceiver 37 or other type of electromagnetic field receiver is also operatively connected to the intelligent control system 30 to link the processor 30 to the electromagnetic field of the user. The use of the E/M transceiver 37 allows the device to link electromagnetically into a personal area network or body area network or other device.

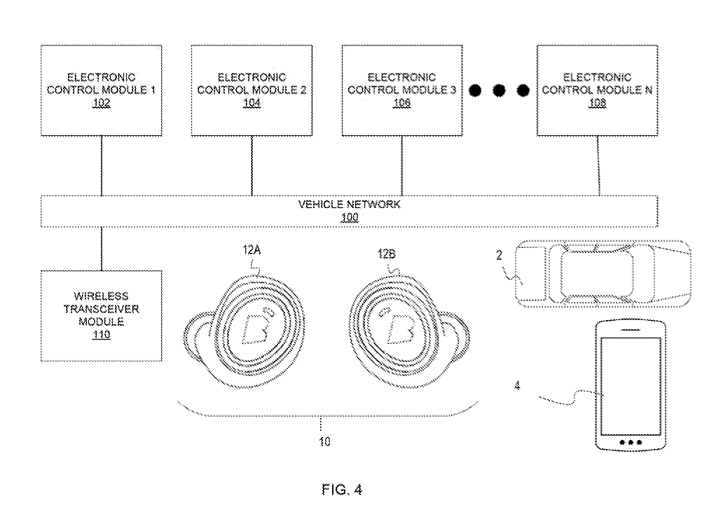

FIG. 4 illustrates another example of one or more wearable ear pieces in operative communication with a vehicle. In FIG. 4, a vehicle network 100 is shown. According to one aspect, the wearable devices 12A, 12B may communicate information through a vehicle network 100 associated with a vehicle 2. Data, instructions, geospatial positions, or routing information may be communicated over the vehicle network 100 or vehicle bus to and from the wearable devices. Protocols which are used may include a Controller Area Network (CAN). Local Interconnect Network (LIN), or others including proprietary network protocols or network protocol overlays.

Various types of electronic control modules 102, 104, 106, 108 or electronic control units may communicate over the network 100 of the vehicle. These may include electronic modules such as an engine control unit (ECU), a transmission control unit (TCU), an anti-lock braking system (ABS), a body control module (BCM), a door control unit (DCU), an electric power steering control unit (PSCU) a human-machine interface (HMI), powertrain control module (PCM), speed control unit (SCU), telematic control unit (TCU), brake control unit (BCM), battery management system, vehicle navigation system and numerous others. Any number of electronic control modules may be operatively connected to the vehicle network 100.

In one embodiment a wireless transceiver module 110 is operatively connected to a vehicle network 100 and it is the wireless transceiver module 110 which is m operative communication with one or more wearable devices such as wearable ear piece 12A, 12B.

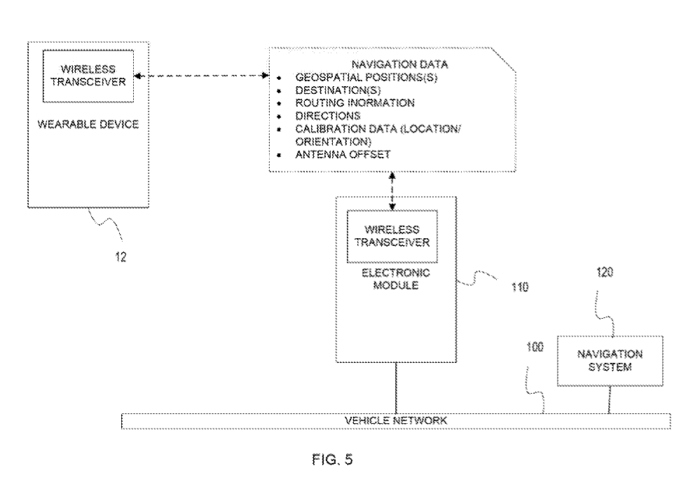

As shown in FIG. 5, one or more wearable devices 12 (including one Or more ear pieces from one or more different vehicle occupants) may communicate with a navigation system 120 of a vehicle. Although the communication may be performed directly between the navigation system 120 and one or more ear pieces 12, in one embodiment a wireless transceiver module 110 may be operatively connected to the wearable ear piece 12 after the transceiver module 110 connects with or forms a wireless linkage with one or more of the ear pieces 12. The wireless transceiver module 110 may use any number of different types of communications and protocols including Bluetooth, Bluetooth Low Energy (BLE), ultra-wideband, or otherwise.

According to another aspect, there are various forms of interaction between the navigation system of a vehicle and one or more wearable devices. In particular, a navigation system associated with one or more wearable devices such as earpieces may integrate with the navigation system of a vehicle.

According to one example one or more earpieces may provide a voice assistant for providing instructions to a user but the one or more earpieces may not have a geolocation system such as a global positioning system (GPS) receiver or GLOSNASS receiver or other geolocation system. However, the one or more earpieces may each have one or more inertial sensors which may be used to track movement of an individual. Thus, to determine geolocation or geospatial position, the one or more wearable devices may communicate with a mobile device or vehicle navigation system which includes a geolocation system. It is further contemplated that once an earpiece knows of or is calibrated to a particular geoposition, the earpiece may use information from its inertial sensors to update or track changes in its geoposition.

For example, when an individual is sitting in a vehicle (Cr otherwise proximate the vehicle), the earpiece may request and/or receive geoposition information from the vehicle. Thus, the earpiece may use the geoposition to calibrate or re-calibrate itself to an accurate geoposition. It is contemplated that the more precise the geoposition information, the more precise the position the individual should be located at when calibrating and that there be an appropriate offset between the position of the GPS antenna of the vehicle and the position of the earpieces(s) (or other wearable device).

In addition to calibrating location, calibration may include orientation or heading information. Thus, not only the position is used but the direction the vehicle (and a driver of the vehicle seated in the driver's seat) is facing may be used for calibration.

The ear piece may also provide directions to a user in various ways. This may include by providing voice feedback to the user regarding their movement. For example, “Please exit the vehicle and look to the vehicle's left. You should see the main entrance of the shopping mall. Do you see it?” The user may then confirm that they see it such as by saying “Yes” or nodding their head up and down to indicate that they do, or just walking towards the main entrance. The ear piece may correct the user at any time or provide helpful prompts such as “Look towards the right.” Thus, directions and directional feedback from the earpiece may be provided in various ways to a user until they arrive at their intended destination.

It is further contemplated that once an individual decides to navigate to a certain place, portions of the journey may be made by vehicle and portions may be made otherwise such as by walking. Thus, for example, suppose an individual wishes to visit a particular store which happens to be inside a mall. The individual may make this decision while at borne (or elsewhere) and may be outside of their vehicle at the time. For example, the individual may say “Take me to the nearest Apple Store” to a voice assistant associated with the earpiece either directly or indirectly through a mobile device or other device associated with the earpiece. Suppose the store is within a shopping mall. The directions can begin by telling the individual that they will need to drive. Once in the car, it is contemplated that navigation may be handed off from the earpieces to the vehicle navigation system. The vehicle navigation system may then route the individual to the mall or a parking spot near the mall. It is further contemplated that once the vehicle navigation system determines that the user has arrived at the destination of the shopping mall, the vehicle navigation system may then handoff navigation back to the earpiece (either directly or indirectly through a mobile device) such that the earpiece may be used to navigate the person on foot to the mall. Any handoffs between the earpiece and the vehicle navigation system are preferably seamless.

Although an earpiece is one example of a wearable device that may be used, it is contemplated that other types of wearable devices may be used instead including watches, glasses, jewelry, and articles of clothing. In addition, instead of a wearable device a mobile device such as a phone may be used. If the device includes a GPS receiver or other type of geolocation receiver then that device may be used instead of or in addition to an inertial sensor.

It is further contemplated that the vehicle navigation system may be associated with an autonomous or self-driving vehicle. If this is the case, the handoff from the earpieces or mobile device to the vehicle at the beginning of the journey and the handoff from the vehicle back to the earpieces or mobile device after the end of the vehicle trip may be performed in a similar manner.

Various methods, system, and apparatus have been shown and described relating to vehicles with wearable integration or communication. The present invention is not to be limited to these specific examples but contemplates any number of related methods, system, and apparatus and these examples may vary based on the specific type of vehicle, the specific type of wearable device, and other considerations.

What is claimed is:

1. A system comprising:
a vehicle;
a vehicle network disposed within the vehicle;
a navigation system disposed within the vehicle;
wherein the navigation system is configured to wirelessly communicate with at least one wireless earpiece to communicate navigation data to or from the at least one wireless earpiece.

2. The system of claim 1 wherein the navigation data includes a geospatial position.

3. The system of claim 1 wherein the navigation data includes directions.

4. The system of claim 3 wherein the directions include a first subset of directions for directions for use when driving the vehicle and a second subset of directions for directions for use when walking.

5. The system of claim 1 wherein the navigation data includes destination data.

6. The system of claim 1 Wherein the navigation data includes calibration data.

7. The system of claim of claim 1 wherein the system limber includes the at least one wireless earpiece and wherein the at least one wireless earpiece comprises an inertial sensor.

8. The system of claim 7 wherein the at least one wireless earpiece further comprises a processor operatively connected to the inertial sensor and wherein the processor is configured to update a current position based on changes in position determined by the inertial sensor.

9. The system of claim 8 wherein the processor is configured to calibrate with a geospatial position when the at least one wireless earpiece is within the vehicle.

10. The system of claim 9 wherein the processor is configured to calibrate with a geospatial position when the at least one wireless earpiece is worn by a driver of the vehicle seated in a driver's seat.

11. The system of claim 10 wherein the navigation data includes an offset defining a distance between a geolocation system antenna of the vehicle and a position for use in calibration of the at least one wireless earpiece.

12. A method of navigation using a vehicle navigation system of a vehicle and a wearable device, the method comprising:
computing directions from a current location to at destination using the vehicle navigation system wherein a first part of the directions are driving directions to an intermediate location wherein a second part of the directions are walking directions from the intermediate location to the destination;
electronically handing off navigation from the vehicle navigation system to the wearable device such that the wearable device provides the walking directions from the intermediate location to the destination after arrival at the intermediate location.

13. The method o claim 12 wherein the wearable device is ate ear piece.

14. The method of claim 12 wherein the wearable device comprises at least one inertial sensor for tracking movement.

15. The method of claim 14 further comprising calibrating position of the wearable device to position of the vehicle.

16. The method of claim 15 further comprising calibrating orientation of the wearable device to the position of the vehicle.
